(19) United States
(12) Patent Application Publication
(10) Pub. No.: US 2013/0035050 A1
(43) Pub. Date: Feb. 7, 2013

(54) Antenna and Receiver Circuit

(71) Applicants: Yuan Gao, Singapore (SG); Nair Murli, Singapore (SG); Yuanjin Zheng, Singapore (SG)

(72) Inventors: Yuan Gao, Singapore (SG); Nair Murli, Singapore (SG); Yuanjin Zheng, Singapore (SG)

(73) Assignee: Agency for Science, Technology and Research, Singapore (SG)

(21) Appl. No.: 13/521,888

(22) PCT Filed: Jan. 13, 2010
(86) PCT No.: PCT/SG10/00007

§ 371 Date: Oct. 8, 2012

(51) Int. Cl. H04B 1/06; H04B 1/18; H01Q 13/10

(52) U.S. Cl. 455/193.1; 343/770; 455/269

(57) ABSTRACT

According to one aspect of the invention, there is provided an antenna including: a substrate; a conductive layer formed on a portion of a top surface of the substrate; a first slot formed within the conductive layer; a conductive stub disposed within the first slot, the conductive stub tuned to reject a first frequency band; and a second slot formed within the conductive layer, the second slot tuned to reject a second frequency band.

### TECHNICAL FIELD

The invention relates to an antenna and a receiver circuit.

### BACKGROUND

By transmitting signals with low power density through an ultra-wideband (UWB) spectrum, UWB systems can achieve high speed data rate communication with low power consumption.

However, the performance of the UWB systems may be degraded from interference that may exist due to the presence of signals from other existing wireless communication systems. For a 3-5 GHz IR-UWB system, interference sources are for example signals from a 802.11a WLAN system, which occupy the 5-6 GHz spectrum; and signals from a 802.11b/g WLAN system covering the 2.4-2.48 GHz frequency band. In addition, the deployment of WiMax system in the 3.5 GHz frequency band also introduces inband interference. Without proper suppression, a strong interference signal from WLAN or WiMax systems can saturate a UWB RF front-end easily and desensitise the receiver. Hence, robustness to both the in-band/out-band interference is important to a UWB receiver front-end.

In conventional receivers, a band-pass filter is placed between the antenna and the RF front-end to filter out the out-of-band interference signals. In order to block in-band interference, band-pass filters with multiple stop-band function have been proposed. However, these filters are usually implemented on a PCB board, leading to an increase in the circuit size and also resulting in additional pass-band insertion loss. Since this filter is before an amplifier, this insertion loss will directly contribute to the increase of input referred noise figure, leading to degraded receiver sensitivity.

There is thus a need to improve inband and out-of-band interference rejection of receivers and also to provide an integrated system that suppresses inband outband interference without system size increase and compromise in system performance for practical UWB application.

### SUMMARY

According to various embodiments, there is provided an antenna including: a substrate; a conductive layer formed on a portion of a top surface of the substrate; a first slot formed within the conductive layer; a conductive stub disposed within the first slot, the conductive stub tuned to reject a first frequency band; and a second slot formed within the conductive layer, the second slot tuned to reject a second frequency band.

According to various embodiments, the conductive layer may be a layer capable of receiving and sending signals. The first slot and the second slot may be enclosed areas etched from the conductive layer such that at least a portion of the enclosed area of the first slot and the second slot is devoid of the conductive layer, thereby leaving exposed substrate. The conductive stub may be made of the same material as the conductive layer or the conductive stub may be made of different material which is capable of receiving and sending signals.

According to various embodiments, the conductive layer may have any one of the following shapes: circular, trapezoidal or elliptical. The first slot may be formed from any one of the following shapes: circular, rectangular or elliptical. The conductive stub may have a rectangular shape or any one of the following other shapes: a square, a triangle, a circle or an ellipse. The second slot may be formed from any one of the following shapes: arc, arrowhead or polygonal.

In one embodiment, the second slot may partially surround the first slot. In other embodiments, the second slot may not surround the first slot.

According to various embodiments, there is provided a receiver circuit including an antenna including: a substrate; a conductive layer formed on a portion of a top surface of the substrate; a first slot formed within the conductive layer; a conductive stub disposed within the first slot, the conductive stub tuned to reject a first frequency band; and a second slot formed within the conductive layer, the second slot tuned to reject a second frequency band; an amplifier connected to the antenna; and a notch filter connected to the amplifier.

According to various embodiments, there is provided a receiver circuit including a notch filter, wherein the notch filter includes an active element configurable to change a frequency rejection band of the notch filter.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a block level representation of front-end architecture of a receiver circuit built in accordance to an embodiment of the present invention.

FIG. 2 shows a side view of the antenna, built in accordance to an embodiment of the present invention, of FIG. 1.

FIG. 3 shows a view of the antenna, built in accordance to an embodiment of the present invention, of FIG. 1.

FIGS. 3A to 3I each show a view of an antenna built in accordance to an embodiment of the present invention.

FIG. 4 shows a circuit level implementation, built in accordance to an embodiment of the present invention, of the amplifier shown in FIG. 1.

FIG. 5A shows a circuit level implementation, built in accordance to an embodiment of the present invention, of the notch filter shown in FIG. 1.

FIG. 5B shows an equivalent circuit diagram of the notch filter shown in FIG. 1.

FIG. 6 shows the measured normalized receiver front-end transfer function of a receiver circuit built in accordance to an embodiment of the present invention.

### DESCRIPTION

While embodiments of the invention have been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced. It will be appreciated that common numerals, used in the relevant drawings, refer to components that serve a similar or the same purpose.

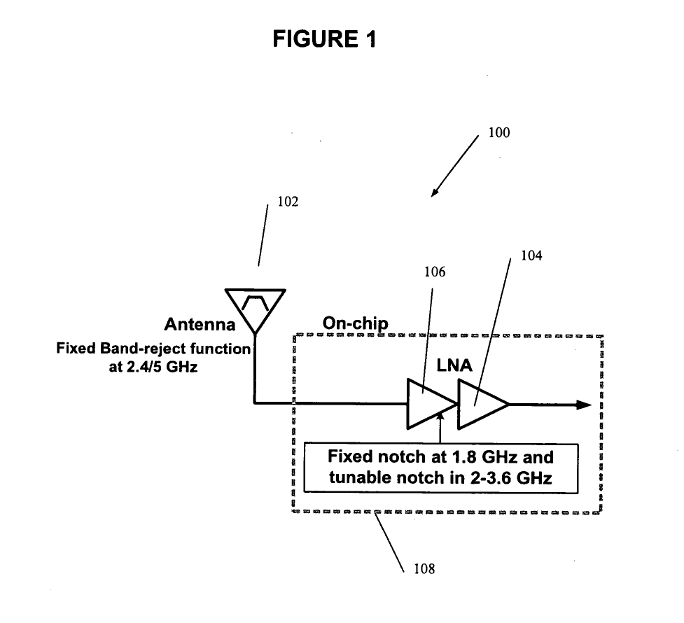

FIG. 1 shows a block level representation of front-end architecture 100 of a receiver circuit 108 built in accordance to an embodiment of the present invention.

The front-end architecture 100 includes an antenna 102, a notch filter 104 and an amplifier 106. A low noise amplifier (LNA) may be used for the amplifier 106. The LNA 106 is connected to the antenna 102, while the notch filter 104 is connected to the LNA 106.

In the embodiment shown in FIG. 1, the antenna 102 may be a planar UWB (ultra wide band) antenna designed to have a first frequency band rejection at around 5.2 GHz and a second frequency band rejection at around 2.4 GHz. The antenna 102 facilitates out-of-band rejection, i.e. filtering interference that may occur from signals in the 2.4 GHz and 5.2 GHz frequency bands. The LNA 106 is equipped with a fixed rejection frequency band (or notch) at around 1.8 GHz and a tunable notch between the frequencies of about 2 GHz to about 3.6 GHz. The LNA 106 facilitates inband rejection, i.e. filtering interference that may occur from signals between the 2.4 GHz and 5.2 GHz frequency bands.

Consider a known UWB receiver structure (not shown) which includes a conventional antenna coupled to an on-board band pass filter, which is used to facilitate out-of-band frequency rejection. Comparing the front-end architecture 100 with the known UWB receiver structure, the front-end architecture 100 eliminates need of having an on board band pass filter. This leads to a reduced system size. Further, by eliminating the need for an on-board band pass filter, insertion loss is reduced, thereby improving receiver sensitivity.

The front-end architecture 100 has the following advantages over the known UWB receiver structure. By combining the antenna 102 and the LNA 106 frequency band rejection ability, the rejection specification of each block (104 and 106) will be alleviated, reducing the design difficulty of the LNA 106 and the notch filter 104. Usually, the band-notch antenna 102 alone can provide 8-10 dB attenuation in the 2.4 GHz band, hence the LNA 106 only needs to provide 10 dB attenuation in the 2.4 GHz band. Furthermore, by tuning the notch frequency of LNA 106 using a varactor, the total notch bandwidth in the range of 2.4 GHz can be increased. On the other hand, the 5.2 GHz attenuation of the LNA 106 is around 5 dB, with the antenna 102 contributing another 10-15 dB attenuation to meet design specifications.

Another advantage of the front-end architecture 100 is the elimination of bulky pre-select and band-notch filters by embedding the out-of-band frequency rejection function into the antenna 102 (without increasing the size of the antenna 102) and on-chip in the integrated circuit, hence reducing the system size.

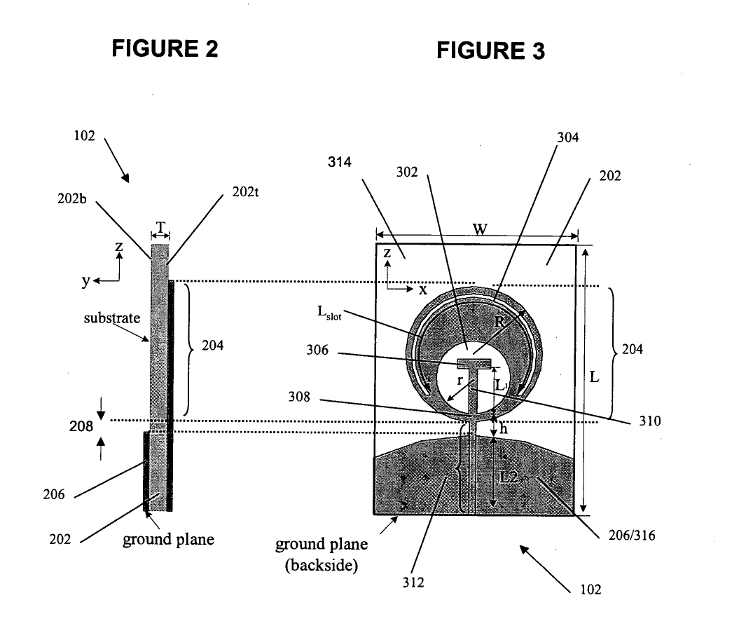

FIG. 2 shows a side view of the antenna 102 of FIG. 1. The antenna 102 has a substrate 202 having a top surface 202t and a bottom surface 202b opposite the top surface 202t. Conductive layers 204 and 206 are formed on each of the top and bottom surfaces 202t and 202b respectively.

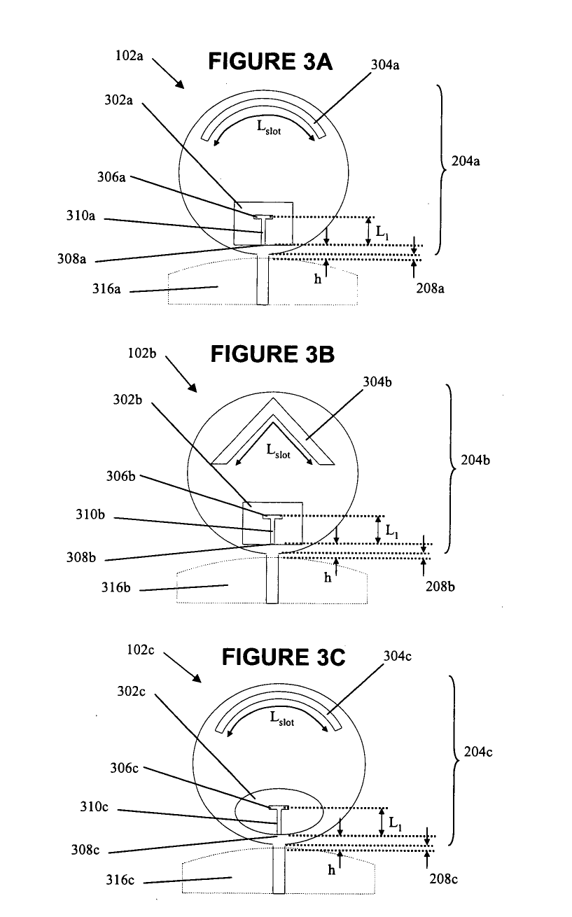

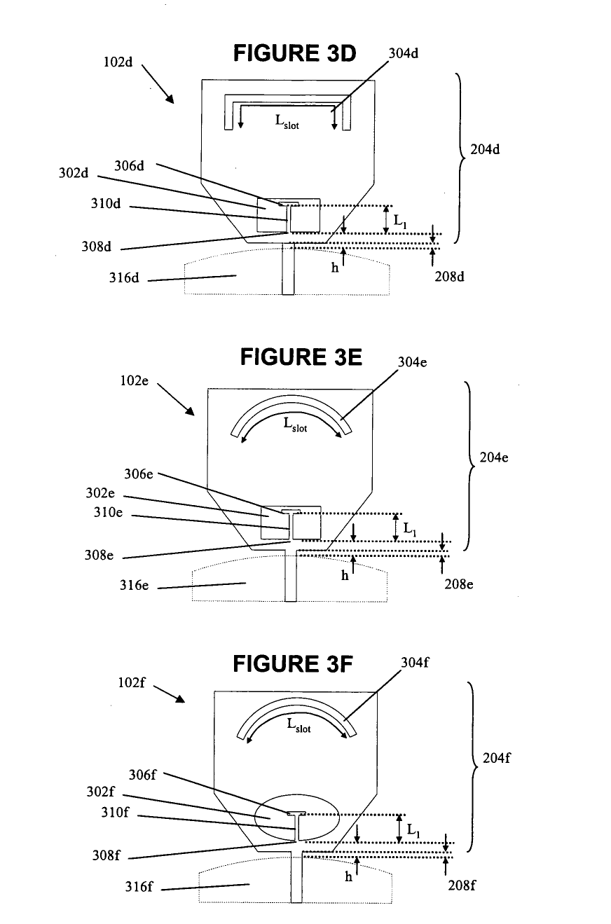

FIG. 3 shows a view of the substrate 202 where both the conductive layer 204 on the top surface 202t and the conductive layer 206 on the bottom surface 202b are shown. It will be appreciated that the view shown in FIG. 3 does not mean that both conductive layers 204 and 206 are on a common surface. Rather, FIG. 3 serves to illustrate how the conductive layer 206 on the bottom surface 202b is positioned relative to the conductive layer 204 on the top surface 202t.

From FIG. 3, it can be seen that the antenna 102 includes the substrate 202. The conductive layer 204 is formed on a portion of the top surface 202t of the substrate 202. A first slot 302 is formed within the conductive layer 204. A conductive stub 306 is disposed within the first slot 302, the conductive stub 306 tuned to reject a first frequency band. A second slot 304 is also formed within the conductive layer 204, the second slot 304 tuned to reject a second frequency band.

In the embodiment shown in FIG. 3, the antenna 102 has a planar monopole structure with band-notch function at around 2.4 and around 5.2 GHz.

The substrate 202 has a dielectric constant εᵣ of around 2.33 and a thickness T of around 0.63 mm. The substrate 202 has a length L of around 40 mm and a width W of around 30 mm. It will be appreciated that for other dielectric constant εᵣ values, the length L and width W values will vary accordingly.

The conductive layer 204 is disposed within the substrate 202, so that the conductive layer 204 is surrounded by an area of exposed substrate. The conductive layer 204, is capable of receiving and sending signals (i.e. is also a radiating element). Within the conductive layer 204, the conductive stub 306 is connected to a segment 308 of the first slot 302 via a conductive strip 310. In this manner, the conductive stub 306 and the conductive strip 310 form a T-shaped conductor, accommodated within the space provided by the first slot 302.

The T-shaped conductor has a length L₁ (L₁ is also the length of the conductive strip 310 within the first slot 302) of around 6 mm. The conductive strip 310 extends linearly beyond the segment 308 to form a feed line 312 of the antenna 102. A signal received by the antenna 102 is transmitted to the LNA 106 and the notch filter 104 via the feed line 312. Signals to be transmitted by the antenna 102 are also sent through the feed line 312.

The second slot 304 is adjacent to a portion of a perimeter of the conductive layer 204 and has a curved slot shape corresponding to the perimeter of the conductive layer 204. As shown in FIG. 3, the second slot 304 does not extend to cover the entire portion adjacent to the perimeter of the conductive layer 204. In the embodiment shown in FIG. 3, the second slot 304 has an arc length Lₛₗₒₜ of around 32 mm and partially surrounds the first slot 302.

The conductive layer 204 has a circular shape and the first slot 302 has a circular shape with a radius r smaller than a radius R of the conductive layer 204. In this manner, the conductive layer 204 forms a ring monopole, with an outer radius R length around 10.5 mm and an inner radius r of length around 5 mm. The circular shape of the conductive layer 204 provides the antenna 102 with a wideband characteristic.

There is an offset L_{D} of length around 4 mm along a z axis 314 (i.e. along the plane of the top surface 202t of the substrate 202) between the centers of the circular shaped conductive layer 204 and the circular shaped first slot 302. Varying this offset L_{D} provides a means to control antenna matching of the antenna 102.

The conductive layer 206 (formed on a portion of the bottom surface 202b of the substrate 202) serves as a ground plane 316 of the antenna 102. The finite ground plane 316, having length L₂ of around 12 mm is printed to only cover the microstrip feed line 312. The ground plane 316 does not have a conventional rectangular shape, but rather a trapezoidal shape (as shown in FIG. 3), so as to minimize ground plane effect. It will be appreciated that other shapes for the ground plane 316 include a semi-circular shape (see ground planes 316a to 316i of FIGS. 3A to 3I respectively). A gap 208 (see FIG. 2) exists between the ground plane 316 and a portion on the bottom surface 202b of the substrate 202 corresponding to where the conductive layer 204 is formed on the portion of the top surface 202t of the substrate 202.

The ground plane 316 is formed on a portion of the bottom surface 202b of the substrate 202 in such way not to overlap with the conductive layer 204 on the top surface 202t of the substrate 202. Accordingly, electromagnetic waves can be radiated or received by the conductive layer 204 without being shielded by the ground plane 316. In this manner, an omnidirectional radiating pattern similar to that of a general monopole antenna can be obtained.

Given that the ground plane 316 does not have a straight profile edge (due to the trapezoidal shape of the ground plane 316), the gap 208 ranges over distances of around 0.3 mm to around 1 mm.

The feed line 312 is a 50Ω microstrip design with metal strip width W₁ of around 1.5 mm. The T-shaped conductor within the first slot 304 has the same width as the microstrip feed line 312.

At the resonance frequency of the conductive strip 310, the current distribution of the circular ring monopole (i.e. the conductive layer 204) will be disrupted, resulting in the malfunction of ring monopole in the resonant frequency range. The expression for the approximate notch frequency calculation (which is also the expression for tuning the conductive stub 306) is:

$${f}_{notch 1} = \frac{c}{4 \sqrt{{ɛ}_{r} ( {L}_{1} + h )}} , \qquad ( 1 )$$

where f_{notch1} is the rejected first frequency band, c is the speed of light, εᵣ is the substrate 202 dielectric constant, L₁ the length of the T-shaped conductor and h is the shortest gap between a feed point (denoted segment 308 on FIG. 3) of the conductive layer 204 and a portion on the top surface 202t of the substrate 202 corresponding to where the ground plane 316 is formed on the portion of the bottom surface 202b of the substrate 202. From equation (1), the rejected first frequency band can be changed by tuning the conductive stub 306 as follows. One way of tuning the conductive stub 306 is to vary the length L₁ of the conductive strip 310 connected to the conductive stub 306.

The second slot 304 is tuned according to the expression:

$${f}_{notch 2} = \frac{c}{2 {L}_{slot} \sqrt{{ɛ}_{r}}} , \qquad ( 2 )$$

where f_{notch2} is the rejected second frequency band, c is the speed of light, εᵣ is the substrate 202 dielectric constant and Lₛₗₒₜ is the length of the second slot 304 (being shaped in an arc as shown in FIG. 3). From equation (2), it will be appreciated that the rejected second frequency band can be changed by changing the length of the second slot 304.

In the embodiment shown in FIG. 3, the antenna 102 is adapted to operate in the UWB range (i.e. around 3 GHz to around 5 GHz), wherein the rejected first frequency band f_{notch1} is around 5.2 GHz and the rejected second frequency band f_{notch2} is around 2.4 GHz.

While FIGS. 2 and 3 show a circular shaped first slot 302 with a T-shaped conductor to achieve rejection of a first frequency band f_{notch1} and an arc-shaped second slot 304 to achieve rejection of a second frequency band f_{notch2}, it will be appreciated that other shapes are possible to achieve dual frequency rejection bands. Such other shapes are shown in FIGS. 3A to 3I.

FIGS. 3A to 3I each show a view of an antenna 102a to 102i built in accordance to an embodiment of the present invention. In FIGS. 3A to 3I, it will be appreciated that the antenna substrate (compare FIG. 3) is not shown for the sake of clarity. Also, the respective conductive layers 204a to 204i are shown superimposed over their respective ground planes 316a to 316i, where it does not mean that both the conductive layers 204a to 204i and their respective ground planes 316a to 316i are on a common surface.

The antenna 102 of FIGS. 2 and 3 share similar characteristics to each of the antennas 102a to 102i.

Each of the antennas 102a to 102i has a substrate (not shown) having a top surface and a bottom surface opposite the top surface. A conductive layer 204a to 204i is formed on a portion of each respective top surface of the substrate. A ground plane 316a to 316i is formed on a portion of each respective bottom surface of the substrate. A gap 208a to 208i exists between the respective ground plane 316a to 316i and a portion on the bottom surface of the substrate corresponding to where the respective conductive layer 204a to 204i is formed on the portion of the top surface of the substrate.

A first slot 302a to 302i is formed within the respective conductive layer 204a to 204i. A conductive stub 306a to 306i is disposed within the respective first slot 302a to 302i, the conductive stub 306a to 306i tuned to reject a first frequency band. A second slot 304a to 304i is also formed within the respective conductive layer 204a to 204i, the second slot 304a to 304i tuned to reject a second frequency band.

The conductive stub 306a to 306i is disposed within the respective first slot 302a to 302i, the conductive stub 306a to 306i being connected to a respective segment 308a to 308i of the respective first slot 302a to 302i via a respective conductive strip 310a to 310i. In this manner, the conductive stub 306a to 306i and the respective conductive strip 310a to 310i form a T-shaped conductor, accommodated within the space provided by the respective slot 302a to 302i.

The second slot 304a to 304i is adjacent to a portion of a perimeter of the respective conductive layer 204a to 204i.

The conductive layers 204a to 204c have a circular shape. On the other hand, the conductive layers 204d to 304f have a trapezoidal shape, while the conductive layers 204g to 304i have an elliptical shape. Thus, the conductive layer may be formed from any one of the following shapes: circular, trapezoidal or elliptical.

Further, the first slot 302g has a circular shape. On the other hand, the first slots 302a, 302b, 302d, 302e and 302h have rectangular shapes, while the first slots 302c, 302f and 302i have elliptical shapes. Thus, the first slot may be formed from any one of the following shapes: circular, rectangular or elliptical.

In addition, the second slots 304b, 304e, 304f to 304i are not formed parallel to the portion of the perimeter of the respective conductive layer 204b, 204e, 204f to 204i they are adjacent to. The second slots 304a, 304c, 304e to 304i are arc-shaped and similar to the second slot 304 of FIG. 3. On the second slot 304b has an arrowhead shape, while the second slot 304d has a polygonal shape. Thus, the second slot may be formed from any one of the following shapes: arc, arrowhead or polygonal.

From FIGS. 3, 3A to 3I, it will be appreciated that the design of the antenna is not limited by the shape of the conductive layer, the shape of the first slot or the shape of the second slot. For one embodiment (not shown), a circular shaped conductive layer may incorporate a first slot having a shape that is either circular, rectangular or elliptical; and a second slot having a shape that is either an arc, an arrowhead or a polygon. In another embodiment (not shown), a trapezoidal shaped conductive layer may incorporate a first slot having a shape that is either circular, rectangular or elliptical; and a second slot having a shape that is either an arc, an arrowhead or a polygon. In one more embodiment (not shown), an elliptical shaped conductive layer may incorporate a first slot having a shape that is either circular, rectangular or elliptical; and a second slot having a shape that is either an arc, an arrowhead or a polygon.

In addition, the conductive stub (306, 306a to 306i) of the embodiments of the antenna shown in FIGS. 3 and 3A to 3I has a rectangular shape. In other embodiments (not shown) of the antenna, the conductive stub may have a shape being a square, a triangle, a circle or an ellipse.

Similar to the antenna 102 of FIGS. 2 and 3, at the resonance frequency of the conductive strip 310a to 310i, the current distribution of the respective conductive layer 204a to 204i will be disrupted, resulting in malfunction in the resonant frequency range. The expression for the approximate notch frequency calculation (which is also the expression for tuning each of the conductive stubs 306a to 306i) is:

$${f}_{notch 1} = \frac{c}{4 \sqrt{{ɛ}_{r} ( {L}_{1} + h )}} , \qquad ( 1 )$$

where f_{notch1} is the rejected first frequency band, c is the speed of light, εᵣ is the substrate dielectric constant, L₁ the length of the T-shaped conductor and h (see FIGS. 3A to 3I) is the shortest gap between a feed point (denoted segment 308a to 308i on FIGS. 3A to 3I) of the respective conductive layer 204a to 204i and a portion on the top surface of the substrate corresponding to where the respective ground plane 316a to 316i is formed on the portion of the bottom surface of the substrate. From equation (1), the rejected first frequency band can be changed by tuning each of the conductive stubs 306a to 306i as follows. One way of tuning each of the conductive stubs 306a to 306i is to vary the length L₁ of the conductive strip 310a to 310i connected to the respective conductive stub 306a to 306i.

Each of the second slot 304a to 304i is tuned according to the expression:

$${f}_{notch 2} = \frac{c}{2 {L}_{slot} \sqrt{{ɛ}_{r}}} , \qquad ( 2 )$$

where f_{notch2} is the rejected second frequency band, c is the speed of light, εᵣ is the substrate dielectric constant and Lₛₗₒₜ is the length of the respective second slot 304a to 304i. From equation (2), it will be appreciated that the rejected second frequency band can be changed by changing the length of the respective second slot 304a to 304i.

Each antenna 102a to 102i is adapted to operate in the UWB range (i.e. around 3 GHz to around 5 GHz), wherein the rejected first frequency band f_{notch1} is around 5.2 GHz and the rejected second frequency band f_{notch2} is around 2.4 GHz.

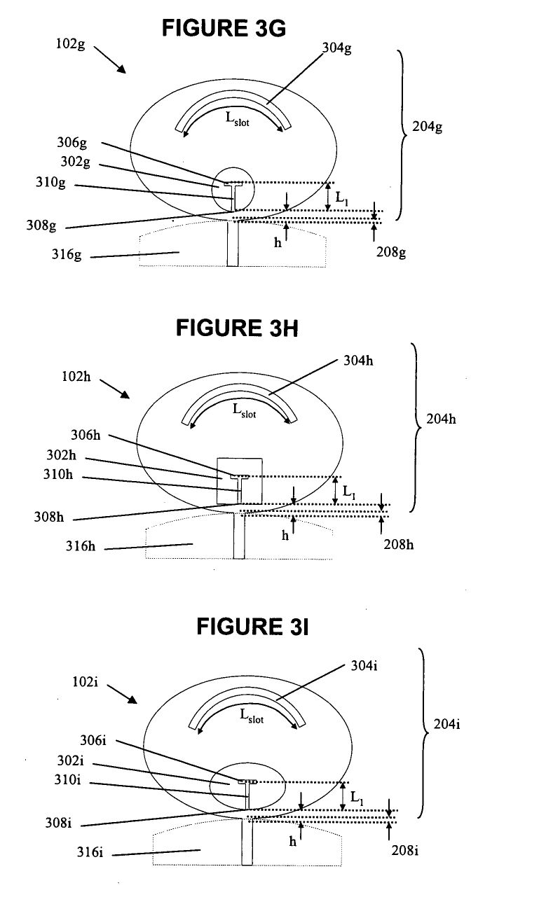

FIG. 4 shows a circuit level implementation, built in accordance to an embodiment of the present invention, of the LNA 106 shown in FIG. 1.

In the embodiment shown in FIG. 4, the LNA 106 is a single-ended four-stage current-reuse resistive feedback LNA. The LNA 106 has a first amplification stage 402 and a second amplification stage 404. The output (labeled Port X in FIG. 4) of the first amplification stage 402 is connected to the input of the second amplification stage 404.

The first amplification stage 402 has two transistors (NM₁ and NM₂), five capacitors (C₃, C₄, C₅, C₆ and C_{decoupling}), three resistors (R_{f1}, VR₁ and R₁) and two inductors (L₂ and L₃).

The gate terminal (NM₂)_{G} of the transistor NM₁ is connected to capacitor C₃. The source terminal (NM₁)_{S} of the transistor NM₁ is connected to a reference potential 406, being at ground level for the embodiment shown in FIG. 4. The drain terminal (NM₁)_{D} of the transistor NM₁ is connected to resistor R_{f1}, inductor L₂ and capacitor C₄. The resistor R_{f1} is in turn connected to the capacitor C₃.

The gate terminal (NM₂)_{G} of the transistor NM₂ is connected to capacitor C₆ and the capacitor C₄. The source terminal (NM₂)_{S} of the transistor NM₂ is connected to capacitor C₅ and the inductor L₂. The capacitor C₅ is in turn connected to the reference potential 406. The drain terminal (NM₂)_{D} of the transistor NM₂ is connected to resistor VR₁, resistor R₁ and capacitor C₇. (Capacitor C₇ belongs to the second amplification stage 404) VR₁ is a variable resistor which is also connected to the capacitor C₆.

The resistor R₁ is connected to inductor L₃. The inductor L₃ is in turn connected to capacitor C_{decoupling} and reference potential 408, denoted V_{dd} in FIG. 4. The capacitor C_{decoupling} is in turn connected to the reference potential 406.

The LNA 106 input matching network includes capacitors C₁, C₂, inductor L₁ and input bonding wire 410. The capacitor C₁ and the inductor L₁ are both connected to the gate terminal (NM₁)_{G} of the first transistor NM₁. The capacitor C₁ turn connected via the bonding wire 410 to an input 412 of the LNA 106. The RF signal from the antenna 102 (see FIG. 1) enters the LNA 106 via input 412. The inductor L₁ is in turn connected to capacitor C₂, whereby the capacitor C₂ is in turn connected to the reference potential 406 via the bonding wire 410.

The inductor L₁ and the capacitor C₂, connected in series, form a serial resonance network 420 which can provide a S21 notch at the serial resonance frequency. This notch frequency f_{notch}_{_{—}}_{LNA1} is determined by:

$${f}_{notch\_LNA 1} = \frac{1}{2 π \sqrt{{L}_{1} {C}_{2}}} \qquad ( 3 )$$

Thus, the serial resonance network 420 determines a frequency rejection band of the amplifier 106. In the embodiment shown in FIG. 4, the LNA 106 provides a fixed notch of around 1.8 GHz. Sample values are as follows: (C₃=2 pF, C₄=3 pF, C₅=4 pF, C₆=1.5 pF, C_{decoupling}=100 pF, L₂=2.4 pF, L₃=2.4 pF, R_{f1}=600 ohm VR₁=800 ohm and R₁=20 ohm)

The second amplification stage 404 has two transistors (NM₃ and NM₄), seven capacitors (C₇, C₈, C₉, C₁₀, C₁₁, C₁₂ and C_{decoupling}), three resistors (R_{f2}, VR₂ and R₂) and three inductors (L₄, L₅ and L₆).

The gate terminal (NM₃)_{G} of the transistor NM₃ is connected to inductor L₄. The source terminal (NM₃)_{S} of the transistor NM₃ is connected to the reference potential 406. The drain terminal (NM₃)_{D} of the transistor NM₃ is connected to resistor VR₂, inductor L₅ and capacitor C₉. The resistor VR₂ is in turn connected to the capacitor C₈. The capacitor C₈ is in turn connected to the capacitor C₇ and the inductor L₄.

The gate terminal (NM₄)_{G} of the transistor NM₄ is connected to capacitor C₁₁ and the capacitor C₉. The source terminal (NM₄)_{S} of the transistor NM₄ is connected to capacitor C₁₀ and the inductor L₅. The capacitor C₁₀ is in turn connected to the reference potential 406. The drain terminal (NM₄)_{D} of the transistor NM₄ is connected to resistor R_{f2}, resistor R₂ and capacitor C₁₂. The other terminal of the capacitor C₁₂ forms the output 414 (also denoted RFOUT) of the LNA 106.

The resistor R₂ is connected to inductor L₆. The inductor L₆ is in turn connected to capacitor C_{decoupling} and the reference potential 408. The capacitor C_{decoupling} is in turn connected to the reference potential 406. Sample values are as follows: (C₇=6 pF, C₈=2.5 pF, C₉=2.5 pF, C₁₀=4 pF, C₁₁=2 pF, C₁₂=2.5 pF, C_{decoupling}=100 pF, L₄=L₅=L₆=1.43 nH, R_{f2}=800 ohm, VR₂=800 ohm and R₂=20 ohm)

The notch filter 104 (see FIG. 1) is connected to the LNA 106 at port x. Thus, the notch filter 104 is connected to where the first amplification stage 402 connects to the second amplification stage 404. However, it will be appreciated that the notch filter 104 may also be connected at other points, such as the input of the first amplification stage 402 or the output of the second amplification stage 404.

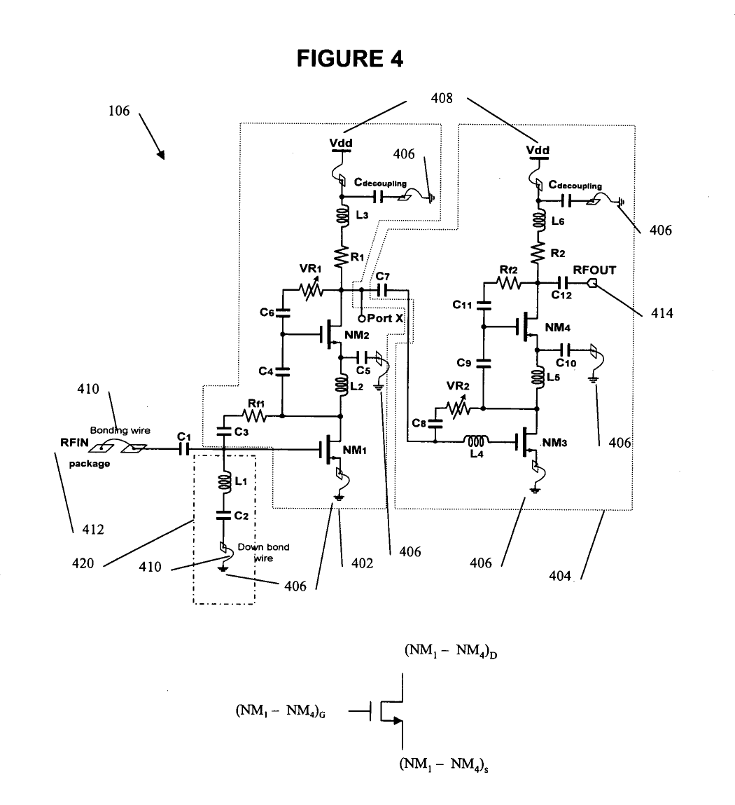

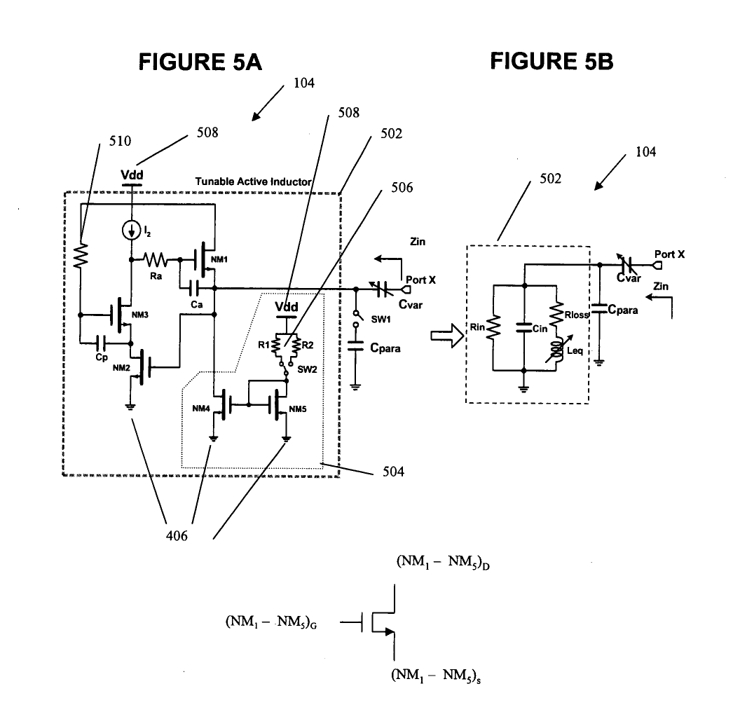

FIG. 5A shows a circuit level implementation, built in accordance to an embodiment of the present invention, of the notch filter 104 shown in FIG. 1.

The notch filter 104 has a tunable active inductor portion 502. The tunable active inductor portion 502 has an active element 504 configurable to change a frequency rejection band of the notch filter 104.

Coupled to the tunable active inductor portion 502 are capacitors Cₚₐᵣₐ and Cᵥₐᵣ. Cₚₐᵣₐ is coupled to the tunable active inductor portion 502 via a switch SW1. Cᵥₐᵣ is in turn connected to port x of the LNA 106 (see FIG. 4) to allow electrical communication between the notch filter 104 and the LNA 106. In the embodiment shown in FIG. 5A, Cᵥₐᵣ is a varactor.

The active element 504 has a current mirror configuration. The current mirror configuration allows tuning an inductance value of the notch filter 104. In this manner, the current mirror configuration provides coarse tuning of the frequency rejection band of the notch filter 104.

The capacitive element Cᵥₐᵣ has one terminal connected to the current mirror configuration and an other terminal connected to the amplifier LNA 106 (see FIG. 4) through port x. The capacitive element Cᵥₐᵣ provides fine tuning of the frequency rejection band of the notch filter 104.

The current mirror configuration includes two transistors NM₄ and NM₅, and a biasing resistor network 506.

The gate terminal (NM₄)_{G} of the first transistor NM₄ is connected to the gate terminal (NM₅)_{G} of the second transistor NM₅. Both the gate terminals (NM₄)_{G} and (NM₅)_{G} are connected to the source terminal (NM₅)_{S} of the second transistor.

In this manner, a control terminal [(NM₅)_{G}] of the second transistor NM₅ is connected to a control terminal [(NM₄)_{G}] of the first transistor NM₄. Also, the control terminal [(NM₅)_{G}] of the second transistor NM₅ is also connected to a first controlled terminal [(NM₅)_{S}] of the second transistor NM₅.

Both the source terminals (NM₄)_{S} and (NM₅)_{S} of the first and the second transistors NM₄ and NM₅ are connected to the reference potential 406. Denoting potential V_{dd} as a first reference potential 508 and reference potential 406 as a second reference potential, a second controlled terminal [(NM₄)_{S}] of the first transistor NM₄ is connected to a second reference potential; and wherein a second controlled terminal [(NM₅)_{S}] of the second transistor NM₅ is connected to the second reference potential.

The drain terminal (NM₄)_{D} of the second transistor NM₄ is connected to the capacitive element Cᵥₐᵣ. In this manner, a first controlled terminal (NM₄)_{D} of the first transistor NM₄ is connected to the capacitive element Cᵥₐᵣ.

A biasing resistor network 506 connects the first controlled terminal (NM₅)_{D} of the second transistor NM₅ to the first reference potential 508. The biasing resistor network 506 includes a plurality of resistors R₁ and R₂ arranged in parallel. Each of the plurality of resistors (R₁ and R₂) is connected to the first reference potential 508. A switch SW2 connects to the first controlled terminal (NM₅)_{D} of the second transistor NM₅. The switch SW2 is operable to connect the first controlled terminal (NM₅)_{D} of the second transistor NM₅ to the first reference potential 508 through connection via a selected one of the plurality of resistors (R₁ and R₂).

The remainder of the tunable active inductor portion 502 includes transistors NM₁, NM₂ and NM₃; resistors Rₐ and 510; a current source I₂ and capacitors Cₚ and Cₐ.

The gate terminal (NM₁)_{G} of the transistor NM₁ is connected to resistor Rₐ and capacitor Cₐ. The source terminal (NM₁)_{S} of the transistor NM₁ is connected to the capacitor Cₐ, the capacitive element Cᵥₐᵣ, the switch SW1, the drain terminal of the (NM₄)_{D} of the first transistor NM₄ [or the first controlled terminal (NM₄)_{D} of the first transistor NM₄] and the gate terminal (NM₂)_{G} of the transistor NM₂. The drain terminal (NM₁)_{D} of the transistor NM₁ is connected to resistor 510, current source I₂ and the first reference potential 508.

The source terminal (NM₂)_{S} of the transistor NM₂ is connected to the second reference potential (i.e. reference potential 406). The drain terminal (NM₂)_{D} of the transistor NM₂ is connected to capacitor Cₚ and the source terminal (NM₃)_{S} of the transistor NM₃.

The gate terminal (NM₃)_{G} of the transistor NM₃ is connected to the resistor 510 and the capacitor Cₚ. The drain terminal (NM₃)_{D} of the transistor NM₃ is connected to the resistor Rₐ and the current source I₂.

In the embodiment shown in FIG. 5A, the first reference potential 508 is of the same potential V_{dd} as the reference potential 408 of FIG. 4. It will be appreciated that the first reference potential 508 may use another potential value.

The tunable active inductor portion 502 forms a third order active notch filter together with the capacitive elements Cₚₐᵣₐ and Cᵥₐᵣ. The proposed active inductor has a capacitor gyrator (C-G) based grounded cascode topology and incorporates a modified implementation of the feedback loss-regulation technique. The loss compensation is achieved by transistor M₃ which creates a series negative resistance which compensates for the losses due to the other active devices in the tunable active inductor 502.

The inductor value of the notch filter 104 is tunable by switching between the current mirror (NM₄, NM₅) biasing resistors R₁ and R₂ using switch SW₂. The control signal for the current mirror also controls switch SW₁. The current mirror topology provides a coarse tuning to the overall notch frequency of the notch filter 104.

On the other hand, fine tuning of the notch filter 104 is achieved by the varactor (Cᵥₐᵣ) which can be controlled by an on-chip DAC (digital to analog converter).

Since both the inductance and the capacitance of the notch filter 104 are tunable, the active notch filter 104 can cover a much wider notch frequency range. In the embodiment shown in FIG. 5A, the frequency rejection band of the notch filter 104 is around 2 GHz to around 3.6 GHz.

FIG. 5B shows an equivalent circuit diagram of the notch filter 104 shown in FIG. 1.

As shown in FIG. 5B, the tunable active inductor portion 502 can be represented by a RLC parallel configuration. The RLC parallel configuration includes resistors Rᵢₙ, Rₗₒₛₛ, capacitor Cᵢₙ and inductor L_{eq}. The resistor Rₗₒₛₛ is connected in series with the inductor L_{eq}. Sample values are as follows: (Cᵢₙ=0.5 pF, L_{eq}=5 nH, Rᵢₙ=2 ohm and Rₗₒₛₛ=1 ohm).

For the embodiments shown in FIGS. 5A and 5B, various parameters of the notch filter 104 can be derived from the following equations.

$$\begin{matrix}{L}_{eq} \approx \frac{{C}_{a} + {C}_{gs 2}}{{g}_{m 1} {g}_{m 2}} & ( 4 ) \\ {R}_{loss} = \frac{{g}_{m 2} {g}_{ds 1} {g}_{ds 3} + {ω}^{2} [ {g}_{m 3} {C}_{gs 2}^{2} - {g}_{m 2} {C}_{gs 2} S ( ω ) ]}{{g}_{m 1} {g}_{m 2}^{2} {g}_{m 3} + {ω}^{2} {g}_{m 1} {g}_{m 3} {C}_{gs 2}^{2}} & ( 5 ) \\ Q = \frac{{ω}_{0} {L}_{eq}}{{R}_{loss}} = \sqrt{\frac{{g}_{m 1} {g}_{m 2} {g}_{m 3} ( {C}_{a} + {C}_{gs 2} )}{{C}_{gs 1} {C}_{ds 1} {g}_{ds 3}^{2}}} & ( 6 ) \\ {f}_{high\_notch} = \frac{1}{2 π \sqrt{{L}_{eq\_low} {C}_{VAR}}} & ( 7 ) \\ {f}_{low\_notch} = \frac{1}{2 π \sqrt{{L}_{eq\_high} ( {C}_{para} + {C}_{VAR} )}} & ( 8 )\end{matrix}$$

C_{gs1} and C_{gs2} are the gate source capacitances of the transistors M₁ and M₂ respectively. C_{ds1} is the drain source capacitance of the transistor M₁. gₘ₁, gₘ₁ and gₘ₃ are the transconductances of the transistors M₁, M₂ and M₃ respectively. g_{ds1}, g_{ds2} and g_{ds3} are physical drain conductances of the transistors M₁, M₂ and M₃ respectively. L_{eq}_{_{—}}_{low} and L_{eq}_{_{—}}_{high} are respectively the lowest and highest inductance values of the notch filter 104, determined by which of the transistors NM₄ and NM₅ (see FIG. 5A) of the current mirror configuration is instantaneously activated. Q is the quality factor of the notch filter 104. Sample values are as follows: (Cₚ=1 pF, Cₚₐᵣₐ=0.8 pF, Cᵥₐᵣ=2 pF, Cₐ=0.5 pF, Rₐ=300 ohm and resistance 510=400 ohm).

Thus, from the above, and returning to FIG. 1, the receiver circuit 108 includes a notch filter (see for instance, notch filter 104 shown in FIG. 5A), wherein the notch filter includes an active element (see for instance, active element 504 having a current mirror configuration, shown in FIG. 5A) configurable to change a frequency rejection band of the notch filter 104.

The front-end architecture 100 provides an integrated solution for inband and out-of-band interference rejection through the receiver circuit 108 and the antenna 102. The antenna 102 and the receiver circuit 108 work in conjunction to provide a high interference rejection. The antenna 102 and the receiver circuit 108 can be co-designed to achieve the desired inband/out-of-band interference mitigation.

In-band frequency refers to the range of around 3 to 5 GHz, while out-of-band frequency refers to the ranges below 3 GHz or above 5 GHz. As the notch filter of the receiver circuit 108 is tunable in the range of around 2 to around 3.6 GHz (i.e. overlapping the lower ranges of both the in-band frequency and the out-of-band frequency), the notch filter provides a tunable filter that operates in the in-band and out-of-band frequencies and may be used for unknown interference searching.

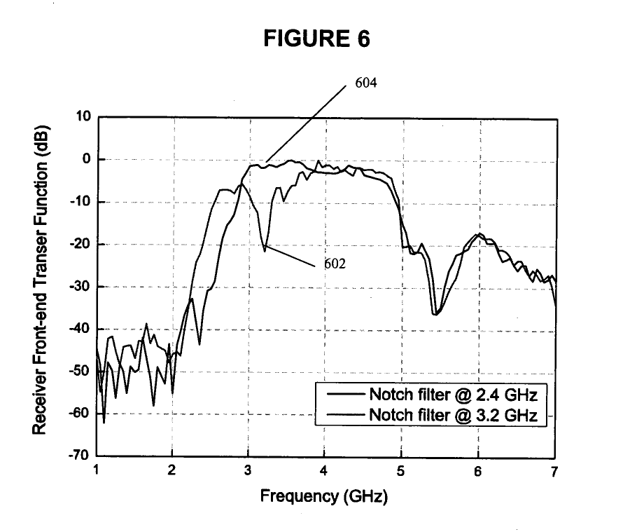

FIG. 6 shows the measured normalized receiver front-end transfer function of a receiver circuit built in accordance to an embodiment of the present invention.

FIG. 6 shows the front-end transfer functions 602 and 604 of the receiver circuit operating with notching at 3.2 GHz and 2.4 GHz respectively. To compare the band-notch performance at these two notch frequencies, each case is normalized to its maximum.

It can be seen a maximum attenuation of 40 dB and a minimum attenuation of 20 dB occurs at a frequency of 2.4 GHz. The maximum attenuation is achieved when the notch filter of the receiver circuit is tuned to this frequency. The maximum attenuation in the 5 GHz frequency band is around 35 dB at a 5.5 GHz frequency. The notch frequency band in the 5 GHz range, where attenuation greater than 20 dB occurs, is from 5.16 GHz to 5.82 GHz. The inband notch produced by the active notch filter is tunable between 1.9 GHz to 3.3 GHz, where the measured attenuation at 3.2 GHz is around 20 dB.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. An antenna comprising:
a substrate;
a conductive layer formed on a portion of a top surface of the substrate;
a first slot formed within the conductive layer;
a conductive stub disposed within the first slot, the conductive stub tuned to reject a first frequency band; and
a second slot formed within the conductive layer, the second slot tuned to reject a second frequency band, wherein the first slot and the second slot have different shapes.

2. The antenna of claim 1, wherein the conductive layer is disposed within the substrate, so that the conductive layer is surrounded by an area of exposed substrate.

3. The antenna of claim 1, wherein the conductive stub is connected to a segment of the first slot via a conductive strip, so that the conductive stub and the conductive strip form a T-shaped conductor.

4. The antenna of claim 1, wherein the second slot is adjacent to a portion of a perimeter of the conductive layer.

5. The antenna of claim 1, further comprising:
a ground plane formed on a portion of the bottom surface of the substrate,
wherein a gap exists between the ground plane and a portion on the bottom surface of the substrate corresponding to where the conductive layer is formed on the portion of the top surface of the substrate.

6. (canceled)

7. (canceled)

8. The antenna of claim 1, wherein the conductive layer has a circular shape and the first slot has a circular shape with a radius smaller than a radius of the conductive layer.

9. (canceled)

10. The antenna of claim 3, wherein the conductive stub is tuned according to the expression
$${f}_{notch 1} = \frac{c}{4 \sqrt{{ɛ}_{r} ( {L}_{1} + h )}}$$
where f_{notch1} is the rejected first frequency band, c is the speed of light, εᵣ is the substrate dielectric constant, L₁ the length of the T-shaped conductor and h is the shortest gap between a feed point of the conductive layer and a portion on the top surface of the substrate corresponding to where a ground plane is formed on the portion of a bottom surface of the substrate.

11. The antenna of claim 1, wherein the second slot is tuned according to the expression
$${f}_{notch 2} = \frac{c}{2 {L}_{slot} \sqrt{{ɛ}_{r}}}$$
where f_{notch2} is the rejected second frequency band, c is the speed of light, εᵣ is the substrate dielectric constant and Lₛₗₒₜ is the length of the second slot.

12. The antenna of claim 1, wherein the antenna is adapted to operate in the UWB range, wherein the rejected first frequency band is around 5.2 GHz and the rejected second frequency band is around 2.4 GHz.

13. A receiver circuit comprising:
an antenna as claimed in claim 1;
an amplifier connected to the antenna; and
a notch filter connected to the amplifier.

14. The receiver circuit of claim 13, wherein the notch filter comprises an active element configurable to change a frequency rejection band of the notch filter.

15. The receiver circuit of claim 14, wherein the active element has a current mirror configuration, the current mirror configuration allowing tuning an inductance value of the notch filter, the current mirror configuration providing coarse tuning of the frequency rejection band of the notch filter.

16. The receiver circuit of claim 15, wherein the notch filter further comprises a capacitive element with one terminal connected to the current mirror configuration and an other terminal connected to the amplifier, the capacitive element providing fine tuning of the frequency rejection band of the notch filter.

17. (canceled)

18. The receiver circuit of claim 16, wherein the current mirror configuration comprises:
a first transistor, a first controlled terminal of which connected to the capacitive element; and
a second transistor, a control terminal of which connected to a control terminal of the first transistor, the control terminal of the second transistor also connected to a first controlled terminal of the second transistor.

19. The receiver circuit of claim 18, wherein the notch filter further comprises a biasing resistor network to connect the first controlled terminal of the second transistor to a first reference potential.

20. The receiver circuit of claim 19, wherein the biasing resistor network comprises:
a plurality of resistors arranged in parallel, each of the plurality of resistors connected to the first reference potential; and
a switch connected to the first controlled terminal of the second transistor, the switch operable to connect the first controlled terminal of the second transistor to the first reference potential through connection via a selected one of the plurality of resistors.

21. The receiver circuit of claim 18, wherein a second controlled terminal of the first transistor is connected to a second reference potential; and
wherein a second controlled terminal of the second transistor is connected to the second reference potential.

22. (canceled)

23. The receiver circuit of claim 13, wherein the amplifier further comprises:
a first amplification stage; and
a second amplification stage, wherein an output of the first amplification stage is connected to an input of the second amplification stage and wherein the notch filter is connected to where the first amplification stage connects to the second amplification stage.

24. The receiver circuit of claim 13, wherein the amplifier further comprises:
a serial resonance network, the serial resonance network determining a frequency rejection band of the amplifier.

25. (canceled)

26. (canceled)

27. A receiver circuit comprising a notch filter, wherein the notch filter comprises an active element configurable to change a frequency rejection band of the notch filter.
